(19) United States
(12) Patent Application Publication
(10) Pub. No.: US 2004/0038615 A1
(43) Pub. Date: Feb. 26, 2004

(54) Production method for plasma display panel unit-use panel and production method for plasma display unit

(76) Inventors: Kazunao Oniki, Tokyo (JP); Hajime Inoue, Kanagawa (JP)

Correspondence Address: Ronald P Kananen, Rader Fishman & Grauer, The Lion Building Suite 501, 1233 20th Street NW, Washington, DC, 20036, US

(21) Appl. No.: 10/344,526

(22) PCT Filed: Jun. 12, 2002
(86) PCT No.: PCT/JP02/05851

(30) Foreign Application Priority Data
Jun. 15, 2001 (JP) 2001-181213
May 17, 2002 (JP) 2002-143445

(51) Int. Cl. H01J 9/24

(52) U.S. Cl. 445/24

(57) ABSTRACT

A manufacturing method for a plasma display panel and a manufacturing method for a plasma display which can improve the purity of a discharge gas in a discharge space after combining panels and sealing the discharge gas into the discharge space, so that the lifetime can be extended and the discharge voltage can be reduced to improve the stability of the discharge voltage. After forming ribs (24) for partitioning discharge spaces (4) and phosphor layers (25R), (25G), and (25B) for emitting light according to ultraviolet rays produced in the discharge spaces (4) on a second substrate (21), the second substrate (21) formed with the ribs (24) and the phosphor layers is burned in a vacuum of 10 Pa or less in a temperature range of 350 to 550° C. Thereafter, the second substrate (21) is combined with a first panel (11) to complete a plasma display (2).

### TECHNICAL FIELD

The present invention relates to a manufacturing method for a plasma display panel and a manufacturing method for a plasma display, and more particularly to a manufacturing method for a plasma display panel and a manufacturing method for a plasma display wherein a rib and a phosphor layer formed on a substrate are burned in a vacuum.

### BACKGROUND ART

Various types of flat panel displays are being considered as a substitute for a cathode ray tube (CRT) mainly spread at present. Such flat panel displays may include a liquid crystal display (LCD), electro-luminescent display (ELD), and plasma display (PDP). Of these displays, the plasma display has many advantages such that a screen size and a viewing angle can be relatively easily enlarged, the resistance against various environmental factors such as temperature, magnetism, and vibrations is high, and the lifetime is long. Accordingly, the applications to a wall-mounted TV for home use and large-size information terminal equipment for public use are being expected.

The plasma display is a display such that a voltage is applied to a discharge cell formed by sealing a discharge gas such as a noble gas in a discharge space and that a phosphor layer in the discharge cell is excited by ultraviolet rays generated according to glow discharge in the discharge gas, thereby obtaining light emission from the phosphor layer. That is, the discharge cell is driven on the principle similar to that of a fluorescent lamp. Usually, hundreds of thousands of discharge cells are collected to configure one display screen. The plasma display is generally classified into a direct-current driven type (DC type) and an alternating-current driven type (AC type) according to the mode of application of the voltage to each discharge cell. Each type has merits and demerits.

In the AC type plasma display, ribs for partitioning the individual discharge cells in the display screen may be arranged in the form of stripes. Accordingly, this type plasma display is suitable for high-resolution. Further, the surface of each electrode is covered with a dielectric layer, so that each electrode is hard to wear, thereby contributing to a long life.

In a currently commercialized AC type plasma display, the stability of discharge and the extension of the life are required. At present, a life of about 30,000 hours in a 42-inch size AC type plasma display is reported. However, in the case that the luminance becomes higher than the current value by two or three times, the life is expected to become shorter. Therefore, the further extension of the life is one of the future problems to be solved.

The life of the current plasma display is determined by deterioration in luminance. Although the deterioration in luminance is considered to be due to a deterioration of each phosphor layer and a deterioration of a protective film, a reduction in purity of the discharge gas is also a large factor.

In a conventional manufacturing method for a plasma display, ribs and phosphor layers are formed on one of the substrates constituting the plasma display, and the substrate formed with the ribs and the phosphor layers is next burned in the air in a furnace. Thereafter, the furnace is evacuated. However, time is required until a sufficient vacuum is reached. Further, after combining the panels and sealing a discharge gas into each discharge space, gases are generated from the phosphor layers and the ribs, causing a reduction in purity of the discharge gas sealed in each discharge space. As a result, the life of the plasma display is reduced.

It is accordingly an object of the present invention to provide a manufacturing method for a plasma display panel and a manufacturing method for a plasma display which can improve the purity of the discharge gas in each discharge space after combining the panels and sealing the discharge gas into each discharge space, so that the lifetime can be extended and the discharge voltage can be reduced to improve the stability of the discharge voltage.

### DISCLOSURE OF INVENTION

According to the present invention, there is provided a manufacturing method for a plasma display panel, including the steps of forming a rib for partitioning a discharge space and a phosphor layer for emitting light according to ultraviolet rays produced in the discharge space, on a substrate; and burning the substrate formed with the rib and the phosphor layer in a vacuum of 10 Pa or less, preferably 1 Pa or less, more preferably 1×10⁻¹ Pa or less in a temperature range of 350 to 550° C. after the forming step.

According to the present invention, there is provided a manufacturing method for a plasma display having a first panel and a second panel with a discharge space defined between the first panel and the second panel, including the steps of forming a rib for partitioning the discharge space and a phosphor layer for emitting light according to ultraviolet rays produced in the discharge space, on a second substrate forming the second panel; and burning the substrate formed with the rib and the phosphor layer in a vacuum of 10 Pa or less, preferably 1 Pa or less, more preferably 1×10⁻¹ Pa or less in a temperature range of 350 to 550° C. after the forming step.

The degree of vacuum in the vacuum burning is limited only by 10 Pa or less, preferably, 1 Pa or less, more preferably 1×10⁻¹ Pa or less, especially preferably 1×10⁻² Pa or less. While it is better to set the vacuum as small as possible, a lower limit for the vacuum is determined by the limitations of a vacuum device or the like.

Further, the burning temperature in the vacuum burning must be set to 350° C. or more, so as to attain the effects of the present invention. However, an upper limit for the burning temperature is determined so as not to degrade the emission characteristics of the phosphor, and is set to preferably 400 to 450° C.

Preferably, the manufacturing method of the present invention further includes the step of burning the phosphor layer on the substrate in the air before the vacuum burning step. The burning temperature in the air is not especially limited, but normally set to about 500 to 600° C.

Preferably, the manufacturing method of the present invention further includes the step of burning the rib on the substrate in the air before the phosphor burning step.

Preferably, the phosphor burning step and the vacuum burning step are performed in the same furnace. Alternatively, the phosphor burning step and the vacuum burning step may be performed in different furnaces.

Preferably, the air atmosphere in the furnace is replaced by a dry nitrogen atmosphere or a dry air atmosphere during or before temperature rising in the phosphor burning step. Alternatively, the air atmosphere in the furnace may be replaced by a dry nitrogen atmosphere or a dry air atmosphere during or after temperature falling in the phosphor burning step. By replacing the air atmosphere in the furnace by a dry nitrogen atmosphere or a dry air atmosphere, any adsorbates such as water and hydrocarbons can be removed more effectively.

Preferably, the air atmosphere in the furnace is replaced by an oxygen-rich atmosphere (an atmosphere containing a higher proportion of oxygen than that in the air) during or after temperature falling in the phosphor burning step. By replacing the air atmosphere in the furnace by an oxygen-rich atmosphere, the oxygen deficiency in a dielectric film and the phosphor layer on the second substrate can be compensated.

Preferably, the manufacturing method for the plasma display according to the present invention further includes the steps of joining the first panel and the second panel after the vacuum burning step to form the discharge space partitioned by the rib between the first panel and the second panel, and sealing a discharge gas having a predetermined pressure into the discharge space.

According to the present invention, the above-mentioned vacuum burning is performed after forming the phosphor layer, so that the purity of the discharge gas in the discharge space can be improved after combining the panels and sealing the discharge gas into the discharge space. Accordingly, the lifetime can be extended and the discharge voltage can be reduced to improve the stability of the discharge voltage.

### BRIEF DESCRIPTION OF DRAWINGS

FIG. 1 is a schematic sectional view in perspective of an essential part of a plasma display according to a preferred embodiment of the present invention.

FIG. 2 is a graph showing the relation between burning time and burning temperature in vacuum burning in an example of the present invention.

FIG. 3 is a graph showing the results of an endurance accelerated test made on plasma displays according to an example of the present invention and a comparison.

FIG. 4 is a graph showing the results of discharge voltage measurement made on the plasma displays according to the example and the comparison.

FIG. 5 is a graph showing the result of Q-mass measurement made on a second panel as a unit according to the example.

FIG. 6 is a graph showing the result of Q-mass measurement made on a second panel as a unit according to the comparison.

### BEST MODE FOR CARRYING OUT THE INVENTION

A preferred embodiment of the present invention will now be described with reference to the drawings.

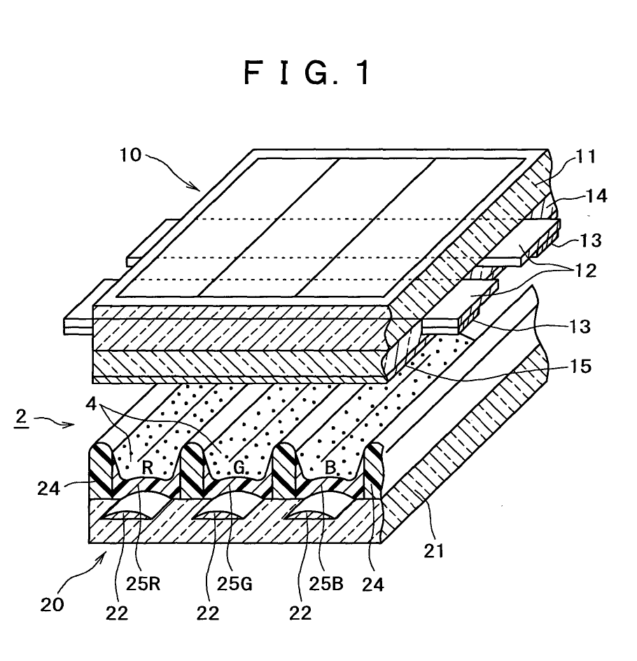

FIG. 1 is a schematic sectional view in perspective of an essential part of a plasma display according to a preferred embodiment of the present invention;

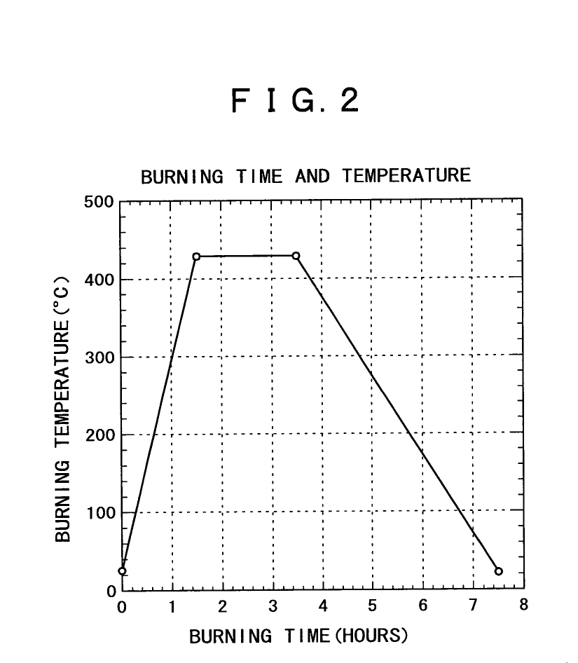

FIG. 2 is a graph showing the relation between burning time and burning temperature in vacuum burning in an example of the present invention;

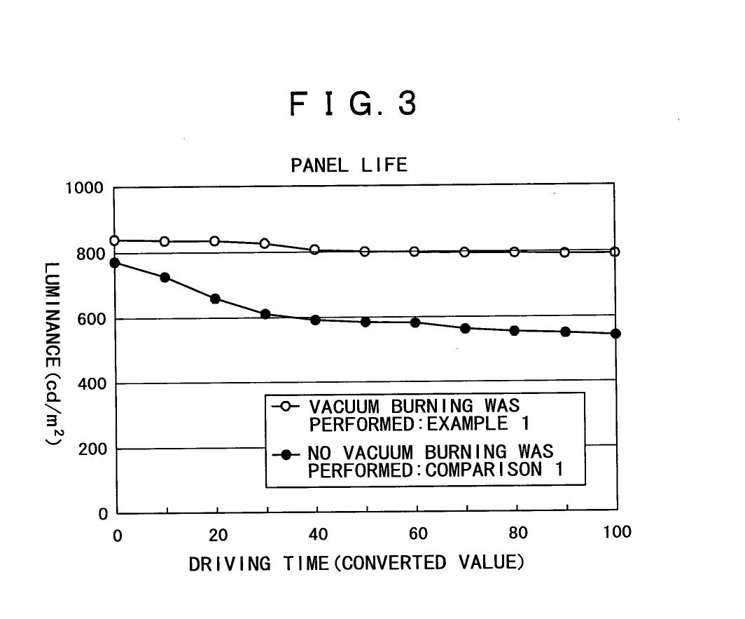

FIG. 3 is a graph showing the results of an endurance accelerated test made on plasma displays according to an example of the present invention and a comparison;

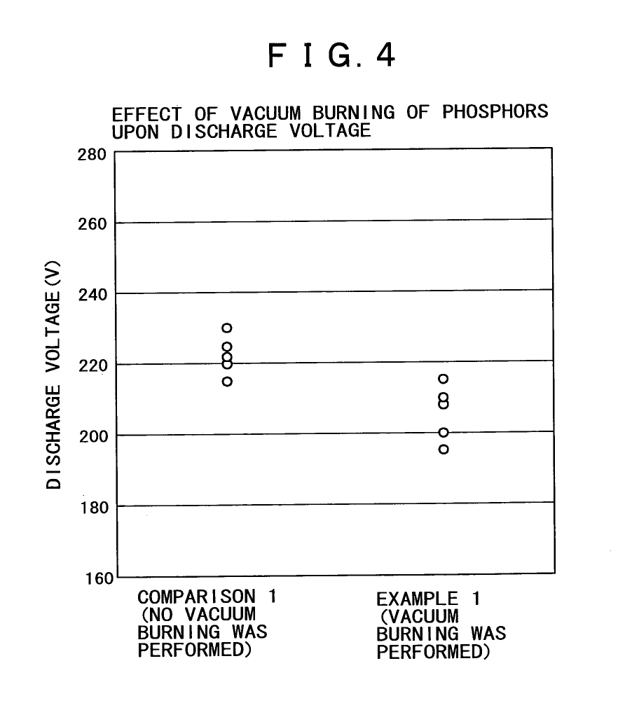

FIG. 4 is a graph showing the results of discharge voltage measurement made on the plasma displays according to the example and the comparison;

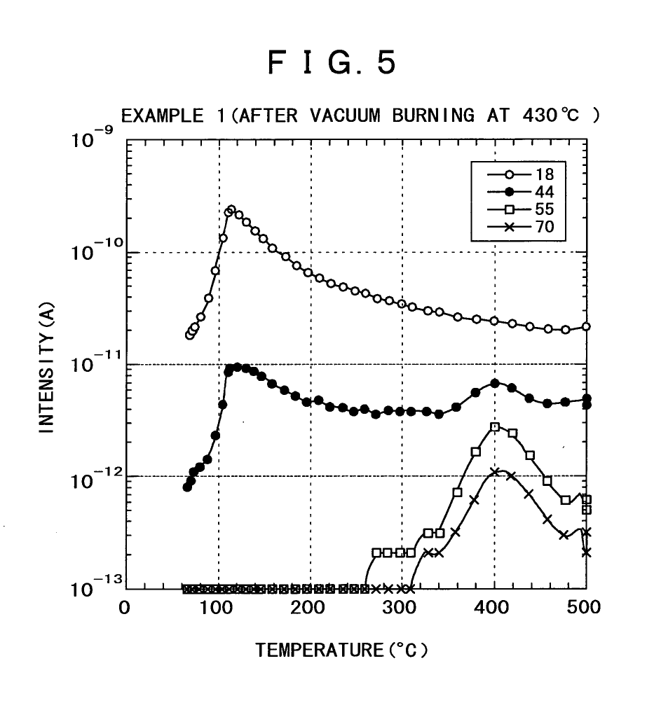

FIG. 5 is a graph showing the result of Q-mass measurement made on a second panel as a unit according to the example; and

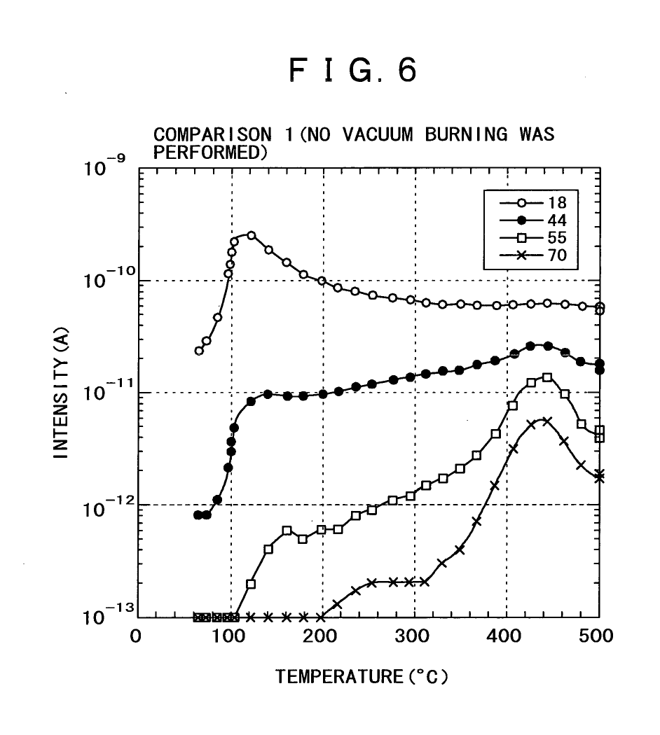

FIG. 6 is a graph showing the result of Q-mass measurement made on a second panel as a unit according to the comparison.

General Configuration of Plasma Display:

There will first be described a general configuration of an alternating-current driven type (AC type) plasma display (which will be hereinafter sometimes referred to simply as plasma display) with reference to FIG. 1.

Reference numeral 2 denotes an AC type plasma display, which belongs to a so-called three-electrode type such that discharge is produced between a pair of sustain electrodes 12. The AC type plasma display 2 is configured by joining a first panel 10 corresponding to a front panel and a second panel 20 corresponding to a rear panel. Light emission from phosphor layers 25R, 25G, and 25B on the second panel 20 is observed through the first panel 10, for example. That is, the first panel 10 is on the side of a display screen.

The first panel 10 is composed of a transparent first substrate 11, a plurality of pairs of sustain electrodes 12 formed of a transparent conductive material and arranged on the first substrate 11 in the form of stripes, a bus electrode 13 formed of a material having an electrical resistivity lower than that of each sustain electrode 12 and provided to reduce the impedance of each sustain electrode 12, a dielectric layer 14 formed on the first substrate 11 so as to cover the bus electrodes 13 and the sustain electrodes 12, and a protective layer 15 formed on the dielectric layer 14. Although the protective layer 15 is not essential, it is preferably formed.

On the other hand, the second panel 20 is composed of a second substrate 21, a plurality of address electrodes (also called data electrodes) 22 arranged on the second substrate 21 in the form of stripes, a dielectric film (not shown) formed on the second substrate 21 so as to cover the address electrodes 22, a plurality of insulating ribs 24 formed on the dielectric film so that each rib 24 is located between the adjacent address electrodes 22 so as to extend parallel to each address electrode 22, and a plurality of sets of phosphor layers each formed on the dielectric film and on the opposed side walls of the adjacent ribs 24. Each set of phosphor layers is composed of a red phosphor layer 25R, a green phosphor layer 25G, and a blue phosphor layer 25B.

FIG. 1 is an exploded perspective view of an essential part of the plasma display 2, and in actual the top of each rib 24 of the second panel 20 is in contact with the protective layer 15 of the first panel 10. The region where each pair of sustain electrodes 12 and each address electrode 22 located between the adjacent ribs 24 overlap each other corresponds to a unit discharge cell. A discharge gas is sealed in a discharge space 4 surrounded by the adjacent ribs 24, each of the phosphor layers 25R, 25G, and 25B, and the protective layer 15. The first panel 10 and the second panel 20 are joined together at their peripheral portions by using frit glass.

The discharge gas sealed in each discharge space 4 is not especially limited. Examples of the discharge gas may include an inert gas such as xenon (Xe) gas, neon (Ne) gas, helium (He) gas, argon (Ar) gas, or nitrogen (N₂) gas, and a mixed gas of these inert gases. The total pressure of the discharge gas sealed is set in the range of about 6×10³ to 8×10⁴ Pa, but not especially limited.

The direction of extension of a projected image of each sustain electrode 12 and the direction of extension of a projected image of each address electrode 22 are substantially orthogonal to each other (this orthogonality is not essential). The region where each pair of sustain electrodes 12 and each set of phosphor layers 25R, 25G, and 25B emitting light of three primary colors overlap each other corresponds to a pixel. Since glow discharge is produced between each pair of sustain electrodes 12 in the same plane, this type of plasma display is referred to as “surface discharge type”. Immediately before applying a voltage between each pair of sustain electrodes 12, a panel voltage lower than a breakdown voltage in the discharge cell is applied to the corresponding address electrode 22, for example, so that wall charges are accumulated in the discharge cell (selection of the discharge cell to be driven) and an apparent breakdown voltage is reduced. Subsequently, the discharge started between each pair of sustain electrodes 12 can be sustained at a voltage lower than the breakdown voltage. In each discharge cell, vacuum ultraviolet rays are produced according to the glow discharge in the discharge cell, and each phosphor layer is excited by irradiation with the vacuum ultraviolet rays to thereby exhibit a specific luminous color according to the kind of the material of the phosphor layer. The vacuum ultraviolet rays have a wavelength according to the kind of the discharge gas sealed in the discharge cell.

The plasma display 2 according to this preferred embodiment is a so-called reflective plasma display, and the emission from the phosphor layers 25R, 25G, and 25B is observed through the first panel 10. Accordingly, the conductive material forming each address electrode 22 may be transparent or opaque. However, the conductive material forming each sustain electrode 12 must be transparent. Whether the conductive material described herein is transparent or opaque is based on the light transmissivity of the conductive material in a luminous wavelength region (visible light region) inherent in the material of each phosphor layer. In other words, if the conductive material forming the sustain electrodes or the address electrodes is transparent to light emitted from the phosphor layers, it can be said that this conductive material is transparent.

Examples of the opaque conductive material may include Ni, Al, Au, Ag, Al, Pd/Ag, Cr, Ta, Cu, Ba, LaB₆, and Ca_{0.2}La_{0.8}CrO₃, which may be used solely or in combination. Examples of the transparent conductive material may include ITO (indium tin oxide) and SnO₂. The sustain electrodes 12 or the address electrodes 22 may be formed by sputtering, evaporation, screen printing, sand blasting, plating, or lift-off process, for example.

The width of each sustain electrode 12 is set in the range of about 200 to 400 ,,m, but not especially limited. The distance between each pair of sustain electrodes 12 is set preferably in the range of about 5 to 150 ,,m, but not especially limited. The width of each address electrode 22 is set in the range of about 50 to 100 ,,m, for example.

Each bus electrode 13 is formed typically from a metal material such as a single-layer metal film of Ag, Au, Al, Ni, Cu, Mo, or Cr, for example, or a multilayer metal film of Cr/Cu/Cr, for example. In the reflective plasma display, each bus electrode 13 formed of such a metal material may reduce the amount of visible light emitted from each phosphor layer and to be transmitted through the first substrate 11, causing a reduction in luminance of the display screen. Therefore, it is preferable to make the width of each bus electrode 13 as small as possible in such a range that an electrical resistance required by the whole of each sustain electrode can be obtained. Specifically, the width of each bus electrode 13 is set smaller than the width of each sustain electrode 12, e.g., in the range of about 30 to 200 ,,m. The bus electrodes 13 may be formed by sputtering, evaporation, screen printing, sand blasting, plating, or lift-off process, for example.

The dielectric layer 14 formed over the surface of the sustain electrodes 12 is formed preferably on the basis of electron beam evaporation, sputtering, vacuum evaporation, or screen printing, for example. The dielectric layer 14 can prevent direct contact of ions and electrons generated in each discharge space 4 with the sustain electrodes 12. As a result, wearing of the sustain electrodes 12 can be prevented. The dielectric layer 14 has a function of accumulating wall charges generated in an address period, a function as a resistor for limiting an excess discharge current, and a memory function of sustaining a discharged state. The dielectric layer 14 may be formed typically of low-melting glass. However, it may be formed of any other dielectric materials.

The protective layer 15 formed on the surface of the dielectric layer 14 so as to be exposed to each discharge space functions to prevent direct contact of the ions and electrons with the sustain electrodes. As a result, wearing of the sustain electrodes 12 can be effectively prevented. The protective layer 15 also functions to emit secondary electrons required for discharge. The protective layer 15 may be formed of magnesium oxide (MgO), magnesium fluoride (MgF₂), or calcium fluoride (CaF₂), for example. Of these materials, magnesium oxide is a suitable material having various properties of chemically high stability, low sputtering rate, high transmissivity of light in the luminous wavelength region of each phosphor layer, and low breakdown voltage. Alternatively, the protective layer 15 may have a multilayer structure formed of at least two kinds of materials selected from the group consisting of the above-mentioned materials.

The first substrate 11 and the second substrate 21 may be formed of high-strain glass, soda lime glass (Na₂O.CaO.SiO₂), borosilicate glass (Na₂O.B₂.O₃ SiO₂) forsterite (2MgO.SiO₂), or lead glass (Na₂.PbO.SiO₂) for example. The materials of the first substrate 11 and the second substrate 21 may be the same or different from each other.

The phosphor layers 25R, 25G, and 25B are formed of a phosphor material selected from the group consisting of a red light emitting phosphor material, a green light emitting phosphor material, and a blue light emitting phosphor material, and they are provided above the address electrodes 22. In the case that the plasma display is adapted to color display, the phosphor layers 25R, 25G, and 25B are specifically arranged in the following manner. The phosphor layer (red phosphor layer 25R) formed of a red light emitting phosphor material is provided above one address electrode 22, the phosphor layer (green phosphor layer 25G) formed of a green light emitting phosphor material is provided above another address electrode 22, and the phosphor layer (blue phosphor layer 25B) formed of a blue light emitting phosphor material is provided above yet another address electrode 22. These phosphor layers for emitting three primary colors constitute one set and are arranged in a predetermined order. As mentioned above, the region where each pair of sustain electrodes 12 and each set of phosphor layers 25R, 25G, and 25B for emitting three primary colors overlap each other corresponds to one pixel. The red phosphor layers, the green phosphor layers, and the blue phosphor layers may be arranged in the form of stripes or lattice.

As the phosphor materials of the phosphor layers 25R, 25G, and 25B, phosphor materials having high quantum efficiency and less saturation to vacuum ultraviolet rays may be suitably selected from any conventional phosphor materials known in the art. In the case of adapting the plasma display to color display, it is preferable to combine phosphor materials so that the color purities are close to the three primary colors defined by NTSC, that a white balance is achieved in mixing the three primary colors, that the afterglow time of each color is short, and that the afterglow times of the three primary colors are substantially the same.

Specific examples of the phosphor materials are as follows:

Examples of the red light emitting phosphor material may include (Y₂O₃:Eu), (YBO₃:Eu), (YVO₄:Eu), (Y_{0.96}P_{0.6}V_{0.40}O₄:Eu_{0.04}), [(Y, Gd) BO₃:Eu], (GdBO₃:Eu) (ScBO₃:Eu), and (3.5MgO.0.5MgF₂.GeO₂:Mn). Examples of the green light emitting phosphor material may include (ZnSiO₂:Mn), (BaAl₁₂O₁₉:Mn), (BaMg₂Al₁₆O₂₇:Mn) (MgGa₂O₄:Mn), (YBO₃:Tb), (LuBO₃:Tb), and (Sr₄Si₃O₈Cl₄:Eu). Examples of the blue light emitting phosphor material may include (Y₂SiO₅:Ce), (CaWO₄:Pb) CaWO₄, YP_{0.85}V_{0.15}O₄, (BaMgAl₁₄O₂₃:Eu), (Sr₂P₂O₇:Eu), and (Sr₂P₂O₇:Sn).

The phosphor layers 25R, 25G, and 25B may be formed by a thick-film printing method, a method of spraying phosphor particles, a method of preliminarily applying an adhesive material to a region where each phosphor layer is to be formed and next depositing phosphor particles to the adhesive material, a method of using a photosensitive phosphor paste and patterning each phosphor layer from the photosensitive phosphor paste by exposure and development, or a method of forming a phosphor layer over the surface of the substrate and next removing an unwanted portion from the phosphor layer by sand blasting, for example.

The phosphor layers 25R, 25G, and 25B may be formed directly on the address electrodes 22 or formed over the address electrodes 22 and the side walls of the ribs 24. Further, the phosphor layers 25R, 25G, and 25B may be formed on the dielectric film provided on the address electrodes 22 or formed over the dielectric film provided on the address electrodes 22 and the side walls of the ribs 24. Further, the phosphor layers 25R, 25G, and 25B may be formed on only the side walls of the ribs 24. The dielectric film may be formed of low-melting glass or SiO₂, for example.

As mentioned above, the ribs 24 extending parallel to the address electrodes 22 are formed on the second substrate 21. The ribs 24 may have a meander structure as a modification. In the case that the dielectric film is formed on the second substrate 21 and the address electrodes 22, the ribs 24 may be formed on the dielectric film in some case. The ribs 24 may be formed of any conventional insulating materials known in the art. For example, the ribs 24 may be formed of a material obtained by mixing metal oxide such as alumina in low-melting glass widely used. Each rib 24 has a width of about 50 ,,m or less and a height of about 100 to 150 ,,m, for example. The pitch of the ribs 24 is about 100 to 400 ,,m, for example.

The ribs 24 may be formed by screen printing, sand blasting, dry film process, or photosensitive process, for example. The dry film process includes the steps of laminating a photosensitive film on a substrate, removing a portion of the photosensitive film in a region where each rib is to be formed by exposure and development, filling openings formed by the above removing step with a material for forming the ribs, and finally burning the substrate. The photosensitive film is burned to disappear by the burning step, and the rib forming material filled in the openings is left to obtain the ribs 24. The photosensitive process includes the steps of forming a rib forming material layer having photosensitivity on a substrate, patterning the rib forming material layer by exposure and development, and finally burning the substrate. By coloring the ribs 24 in black, a so-called black matrix can be formed to thereby obtain a high contrast on the display screen. The ribs 24 may be colored in black by using a color resist material colored in black in the rib forming process.

Each discharge cell is formed by the adjacent ribs 24 formed on the second substrate 21, each pair of sustain electrodes 12 present in the region surrounded by the adjacent ribs 24, each address electrode 22 present in this region, and each of the phosphor layers 25R, 25G, and 25B present in this region. The discharge gas such as a mixed gas is sealed in each discharge cell, more specifically in the discharge space surrounded by the adjacent ribs. The phosphor layer 25R, 25G, or 25B is irradiated with ultraviolet rays emitted on the basis of the AC glow discharge produced in the discharge gas in the discharge space 4, thereby emitting light.

Manufacturing Method for Plasma Display:

A manufacturing method for the plasma display according to the preferred embodiment of the present invention will now be described.

The first panel 10 may be fabricated by the following method. First, an ITO layer is formed by sputtering, for example, on the entire surface of the first substrate 11 of high-strain glass or soda lime glass. The ITO layer is next patterned in the form of stripes by photolithography and etching to thereby form the plurality of pairs of sustain electrodes 12. Each sustain electrode 12 extends in a first direction.

An aluminum film is next formed by evaporation, for example, on the entire surface of the first substrate 11 so as to cover the sustain electrodes 12. The aluminum film is next patterned by photolithography and etching to thereby form the bus electrodes 13 on the sustain electrodes 12 along one side edge thereof for each. Thereafter, the dielectric layer 14 of SiO₂ is formed on the entire surface of the first substrate 11 so as to cover the sustain electrodes 12 and the bus electrodes 13. Further, the protective layer 15 of magnesium oxide (MgO) having a thickness of 0.6 ,,m is formed on the dielectric layer 14 by electron beam evaporation. Thus, the first panel 10 is completed.

The second panel 20 is fabricated by the following method. First, a silver paste is printed in the form of stripes by screen printing on the second substrate 21 of high-strain glass or soda lime glass. The silver paste printed is next burned to thereby form the address electrodes 22. Each address electrode 22 extends in a second direction orthogonal to the first direction. Thereafter, a low-melting glass paste layer is formed on the entire surface of the second substrate 21 by screen printing so as to cover the address electrodes 22. The low-melting glass paste layer is next burned to thereby form the dielectric film.

Thereafter, a low-melting glass paste is printed by screen printing on the dielectric film in a region between the adjacent address electrodes 22. The second substrate 21 is next burned in a burning furnace to form the ribs 24. This burning (rib burning step) is performed in the air at about 560° C. for about two hours.

Thereafter, phosphor slurries of three primary colors are sequentially printed in the regions each defined between the adjacent ribs 24 on the second substrate 21. The second substrate 21 is next burned in the burning furnace to thereby form the phosphor layers 25R, 25G, and 25B each on the dielectric film between the adjacent ribs 24 and on the side walls of the adjacent ribs 24. This burning (phosphor burning step) is performed in the air at about 510° C. for about 10 minutes.

Thereafter, the second substrate 21 formed with the ribs 24 and the phosphor layers 25R, 25G, and 25B is burned under vacuum (vacuum burning step). This burning is performed in a vacuum of 10 Pa or less, preferably 1 Pa or less, more preferably 1×10⁻¹ Pa or less, especially preferably 1×10⁻² Pa or less in a temperature range of 350 to 550° C., preferably 400 to 450° C. The burning temperature and the burning time in this vacuum burning step are determined so that the dielectric film and the ribs 24 on the second substrate 21 are not melted and that the characteristics of the phosphor layers 25R, 25G, and 25B are not lost.

The phosphor burning step and the vacuum burning step may be performed in the same furnace or in different furnaces.

Thereafter, the plasma display is assembled in the following manner. First, a sealing layer is formed over a peripheral portion of the second panel 20 by screen printing, for example. The first panel 10 and the second panel 20 are next attached together and burned to harden the sealing layer. The space defined between the first panel 10 and the second panel 20 is next evacuated and then filled with the discharge gas. Finally, this space is sealed to complete the plasma display 2.

There will now be described an example of the AC glow discharge operation of the plasma display having such a configuration. First, a panel voltage higher than a breakdown voltage Vbd is applied to one of each pair of sustain electrodes 12 for a short period of time. As a result, glow discharge is produced to generate wall charges due to dielectric polarization on the surface of the dielectric layer 14 in the vicinity of the one sustain electrode of each pair. The wall charges are accumulated to reduce an apparent breakdown voltage. Thereafter, a voltage is applied to each address electrode 22 and at the same time a voltage is applied to the one sustain electrode 12 included in any discharge cell not be driven, thereby producing glow discharge between this address electrode 22 and this sustain electrode 12 to erase the accumulated wall charges. This erasing discharge is sequentially performed for all the address electrodes 22. On the other hand, no voltage is applied to the one sustain electrode 12 included in any discharge cell to be driven. As a result, the accumulation of the wall charges is maintained. Thereafter, a predetermined pulse voltage is applied between each pair of sustain electrodes 12 to thereby start glow discharge between each pair of sustain electrodes 12 in the discharge cells in which the wall charges have been accumulated. In each discharge cell, the phosphor layer excited by the irradiation with the vacuum ultraviolet rays emitted on the basis of the glow discharge in the discharge gas contained in the discharge space exhibits a specific luminous color according to the kind of the phosphor material. The phase of the sustain voltage applied to one of each pair of sustain electrodes and the phase of the sustain voltage applied to the other sustain electrode in each pair are shifted from each other by a half period, and the polarity of each sustain electrode 12 is inverted according to the frequency of the alternating current.

According to the manufacturing method for the second panel 20 in this preferred embodiment, the above-mentioned vacuum burning is performed after forming the phosphor layers 25R, 25G, and 25B, so that the purity of the discharge gas in each discharge space 4 can be improved after combining the panels 10 and 20 and sealing the discharge gas into each discharge space 4. Accordingly, the lifetime can be extended and the discharge voltage can be reduced.

Other Preferred Embodiments:

The present invention is not limited to the above preferred embodiment, but various modifications may be made within the scope of the present invention.

For example, the specific structure of the plasma display in the present invention is not limited to the preferred embodiment shown in FIG. 1, but any other structures may be adopted. For example, while the plasma display shown in FIG. 1 is a so-called three-electrode type plasma display, the plasma display according to the present invention may be a so-called two-electrode type plasma display. In this case, one of each pair of sustain electrodes is formed on the first substrate, and the other sustain electrode in each pair is formed on the second substrate. Further, the projected image of one of each pair of sustain electrodes extends in a first direction, and the projected image of the other sustain electrode in each pair extends in a second direction different from the first direction (preferably, substantially perpendicular to the first direction). Thus, each pair of sustain electrodes are opposed to each other. In such a two-electrode type plasma display, the term of “the address electrode” in the description of the above preferred embodiment may be replaced by the term of “the other sustain electrode” as required.

Further, while the plasma display according to the above preferred embodiment is a so-called reflective plasma display such that the first panel 10 serves as a display panel, the plasma display according to the present invention may be a so-called transmissive plasma display. In the transmissive plasma display, however, the emission from each phosphor layer is observed through the second panel 20. Therefore, although the conductive material for forming the sustain electrodes may be transparent or opaque, the address electrodes 22 must be transparent because they are formed on the second substrate 21.

Further, while the phosphor burning step is performed in the air under atmospheric pressure in the above preferred embodiment, the air atmosphere in the furnace may be replaced by a dry nitrogen atmosphere or a dry air atmosphere during or before temperature rising in the phosphor burning step according to the present invention. Alternatively, the air atmosphere in the furnace may be replaced by a dry nitrogen atmosphere or a dry air atmosphere during or after temperature falling in the phosphor burning step. By replacing the air atmosphere in the furnace by a dry nitrogen atmosphere or a dry air atmosphere, any adsorbates such as water and hydrocarbons can be removed more effectively.

Further, the air atmosphere in the furnace may be replaced by an oxygen-rich atmosphere during or after temperature falling in the phosphor burning step. By replacing the air atmosphere in the furnace by an oxygen-rich atmosphere, the oxygen deficiency in the dielectric film and the phosphor layers on the second substrate can be compensated.

### EXAMPLES

Some examples according to the present invention will now be described. The present invention is not limited to the following examples.

### Example 1

The first panel 10 was fabricated by the following method. First, an ITO layer was formed by sputtering, for example, on the entire surface of the first substrate 11 of high-strain glass or soda lime glass. The ITO layer was next patterned in the form of stripes by photolithography and etching to thereby form the plurality of pairs of sustain electrodes 12.

An aluminum film was next formed by evaporation, for example, on the entire surface of the first substrate 11 so as to cover the sustain electrodes 12. The aluminum film was next patterned by photolithography and etching to thereby form the bus electrodes 13 on the sustain electrodes 12 along one side edge thereof for each. Thereafter, the dielectric layer 14 of SiO₂ was formed on the entire surface of the first substrate 11 so as to cover the sustain electrodes 12 and the bus electrodes 13. Further, the protective layer 15 of magnesium oxide (MgO) having a thickness of 0.6 ,,m was formed on the dielectric layer 14 by electron beam evaporation. Thus, the first panel 10 was completed.

The second panel 20 was fabricated by the following method. First, a silver paste was printed in the form of stripes by screen printing on the second substrate 21 of high-strain glass or soda lime glass. The silver paste printed was next burned to thereby form the address electrodes 22. Each address electrode 22 extends in a second direction orthogonal to the first direction. Thereafter, a low-melting glass paste layer was formed on the entire surface of the second substrate 21 by screen printing so as to cover the address electrodes 22. The low-melting glass paste layer was formed and burned to thereby form the dielectric film.

Thereafter, a low-melting glass paste was printed by screen printing on the dielectric film in a region between the adjacent address electrodes 22. The second substrate 21 was next burned in a burning furnace to form the ribs 24. This burning (rib burning step) was performed in the air at about 560° C. for about two hours.

Thereafter, phosphor slurries of three primary colors were sequentially printed in the regions each defined between the adjacent ribs 24 on the second substrate 21. The second substrate 21 was next burned in the burning furnace to thereby form the phosphor layers 25R, 25G, and 25B each on the dielectric film between the adjacent ribs 24 and on the side walls of the adjacent ribs 24. This burning (phosphor burning step) was performed in the air at about 510° C. for about 10 minutes. Thereafter, the second substrate 21 was burned in another burning furnace in a vacuum of 1×10⁻² Pa at 430° C. for two hours as shown in FIG. 2 (vacuum burning). In this vacuum burning, 1.5 hours were required for temperature rising, two hours were required for temperature retention, and four hours were required for temperature falling as shown in FIG. 2. As the materials of the phosphor layers 25R, 25G, and 25B, suitable materials that can be well burned at 510° C. were selected.

Thereafter, the plasma display was assembled in the following manner. First, a sealing layer was formed over a peripheral portion of the second panel 20 by frit dispensing. The first panel 10 and the second panel 20 were next attached together and burned to harden the sealing layer. The space defined between the first panel 10 and the second panel 20 was next evacuated and then filled with the discharge gas. Finally, this space was sealed to complete the plasma display 2.

Comparison 1:

The plasma display 2 was fabricated by a method similar to the method described above in Example 1 except that the vacuum burning for the second panel 20 was not performed.

Evaluation:

An accelerated test was made on the plasma displays in Example 1 and in Comparison 1 by measuring a luminance. The result of this test is shown in FIG. 3. The accelerated test was made by applying a driving frequency (or driving voltage) higher than a rated value. In FIG. 3, the unit for driving time along the horizontal axis is dimensionless in consideration of test time in the accelerated test, and the driving time is not an actual elapsed time.

As apparent from FIG. 3, it was confirmed that the plasma display in Example 1 including the vacuum burning has an advantage over the plasma display in Comparison 1 including no vacuum burning such that the luminance does not decrease with the elapsed time to improve the reliability (life). Further, it was also confirmed that the plasma display in Example 1 including the vacuum burning has another advantage over the plasma display in Comparison 1 including no vacuum burning such that the luminance is higher in absolute value, showing good discharge.

Five samples of the plasma display in Example 1 and five samples of the plasma display in Comparison 1 were subjected to measurement of driving voltages (discharge voltages). The result of this measurement is shown in FIG. 4. As apparent from FIG. 4, it was confirmed that the driving voltage (discharge voltage) according to Example 1 can be reduced by about 20 V as compared with Comparison 1.

Further, prior to assembling of the plasma displays in Example 1 and in Comparison 1, each second panel 20 as a unit was set in a Q-mass measuring device to measure the intensity of detected impurity gases from each second panel 20 as increasing the temperature of each second panel 20. The results of this measurement are shown in FIGS. 5 and 6.

In each of FIGS. 5 and 6, the horizontal axis represents the temperature of each second panel 20, and the vertical axis represents the intensity of detected impurity gases. Further, in each of FIGS. 5 and 6, numerals 18, 44, 55, and 70 indicate the molecular weights of detected impurity gases. Specifically, it is considered that the numeral 18 represents H₂O, for example, the numeral 44 represents CO₂, for example, and the numerals 55 and 70 represent an organic substance and a hydrocarbon, for example.

As compared with Comparison 1 shown in FIG. 6, Example 1 shown in FIG. 5 has an advantage such that the intensity of each impurity gas detected with an increase in temperature is reduced. Accordingly, it is expected that the plasma display assembled by using the second panel in Example 1 has an advantage over the plasma display by using the second panel in Comparison 1 such that the impurity gases in each discharge space can be reduced. As a result, it is considered that abnormal discharge or the like can be reduced in Example 1 as compared with Comparison 1, thereby improving the reliability of the plasma display according to Example 1.

In summary, it became clear that the life of the plasma display can be greatly extended and the stability of discharge can be improved by performing the vacuum burning after forming the phosphor layers. Further, it was confirmed that the impurities in the second panel can be removed by the vacuum burning, thereby reducing abnormal discharge.

### Example 2

After forming the phosphor layers 25R, 25G, and 25B and burning them in the air at 510° C. for 10 minutes in the furnace, the furnace was evacuated to a vacuum of 1×10⁻² Pa at the time the temperature in the furnace lowered to 430° C., and this temperature was subsequently maintained for two hours. The other steps were carried out as in Example 1 to complete the plasma display 2. In other words, the phosphor burning step and the vacuum burning step were performed in the same furnace in Example 2. It was confirmed that Example 2 can exhibit effects similar to those exhibited by Example 1.

### Example 3

In forming the phosphor layers 25R, 25G, and 25B and burning them in the air at 510° C. for 10 minutes, the air atmosphere in the furnace was replaced by a dry nitrogen atmosphere during temperature rising before the furnace temperature reached 430° C. The other steps were carried out as in Example 1 to complete the plasma display 2. In other words, the air atmosphere in the furnace was replaced by a dry nitrogen atmosphere during temperature rising in the phosphor burning step to perform the phosphor burning step. Thereafter, the vacuum burning step was performed. It was confirmed that Example 3 can exhibit effects similar to those exhibited by Example 1 and can exhibit an additional effect that any adsorbates such as water and hydrocarbons can be removed more effectively.

It was further confirmed that similar effects can be obtained also by using dry air passed through a moisture removing filter rather than using dry nitrogen.

### Example 4

In forming the phosphor layers 25R, 25G, and 25B and burning them in the air at 510° C. for 10 minutes, the air atmosphere in the furnace was replaced by a dry nitrogen atmosphere during temperature falling. The other steps were carried out as in Example 1 to complete the plasma display 2. In other words, the air atmosphere in the furnace was replaced by a dry nitrogen atmosphere during temperature falling in the phosphor burning step to perform the phosphor burning step. Thereafter, the vacuum burning step was performed. As in Example 3, it was confirmed that any adsorbates such as water and hydrocarbons can be removed more effectively.

It was further confirmed that similar effects can be obtained also by using dry air passed through a moisture removing filter rather than using dry nitrogen.

### Example 5

In forming the phosphor layers 25R, 25G, and 25B and burning them in the air at 510° C. for 10 minutes, the air atmosphere in the furnace was replaced by an oxygen-rich atmosphere (an atmosphere containing a higher proportion of oxygen than that in the air) during temperature falling. The other steps were carried out as in Example 1 to complete the plasma display 2. In other words, the air atmosphere in the furnace was replaced by an oxygen-rich atmosphere during temperature rising in the phosphor burning step to perform the phosphor burning step. Thereafter, the vacuum burning step was performed. It was confirmed that Example 5 can exhibit effects similar to those exhibited by Example 1 and can compensate the oxygen deficiency in the dielectric film and each phosphor layer on the second substrate 21.

### Example 6

The second substrate 21 was burned in a vacuum of 1 Pa after the phosphor burning step. The other steps were carried out as in Example 1 to complete the plasma display 2.

The gas was sealed into the furnace through a needle valve, and the gas pressure in the furnace was controlled to 1 Pa by evacuating the furnace through a pump as sealing the gas. In the present invention, the vacuum burning may be performed in the condition where the gas is enclosed in the furnace. It was confirmed that Example 6 has an advantage over Comparison 1 such that the life of the plasma display can be greatly extended and the stability of discharge can be improved. Further, it was confirmed that the impurities in the second panel can be removed by the vacuum burning to thereby reduce abnormal discharge. However, these effects are less than those exhibited in Example 1.

Moreover, Example 6 has another advantage over Example 1 such that heat conductivity to the second panel can be improved and the burning time can also be reduced by setting the gas pressure to 1 Pa.

### Example 7

The second substrate 21 was burned in a vacuum of 10 Pa after the phosphor burning step. The other steps were carried out as in Example 1 to complete the plasma display 2.

The gas was sealed into the furnace through a needle valve, and the gas pressure in the furnace was controlled to 10 Pa by evacuating the furnace through a pump as sealing the gas. In the present invention, the vacuum burning may be performed in the condition where the gas is enclosed in the furnace. It was confirmed that Example 7 has an advantage over Comparison 1 such that the life of the plasma display can be greatly extended and the stability of discharge can be improved. Further, it was confirmed that the impurities in the second panel can be removed by the vacuum burning to thereby reduce abnormal discharge. However, these effects are less than those exhibited by Example 1.

Moreover, Example 7 has another advantage over Example 1 such that heat conductivity to the second panel can be improved and the burning time can also be reduced by setting the gas pressure to 10 Pa.

Comparison 2:

The second substrate 21 was burned in a vacuum of 15 Pa after the phosphor burning step. The other steps were carried out as in Example 1 to complete the plasma display 2.

Results similar to those in Comparison 1 were obtained in Comparison 2.

1. A manufacturing method for a plasma display panel, comprising the steps of:
forming a rib for partitioning a discharge space and a phosphor layer for emitting light according to ultraviolet rays produced in said discharge space, on a substrate; and
burning said substrate formed with said rib and said phosphor layer in a vacuum of 10 Pa or less in a temperature range of 350 to 550° C. after said forming step.

2. A manufacturing method for a plasma display panel according to claim 1, wherein said substrate formed with said rib and said phosphor layer is burned in a vacuum of 1 Pa or less in said vacuum burning step.

3. A manufacturing method for a plasma display panel according to claim 1, wherein said substrate formed with said rib and said phosphor layer is burned in a vacuum of 1×10⁻¹ Pa or less in said vacuum burning step.

4. A manufacturing method for a plasma display panel according to any one of claims 1 to 3, further comprising the step of burning said phosphor layer on said substrate in the air before said vacuum burning step.

5. A manufacturing method for a plasma display panel according to claim 4, further comprising the step of burning said rib on said substrate in the air before said phosphor burning step.

6. A manufacturing method for a plasma display panel according to claim 4 or 5, wherein said phosphor burning step and said vacuum burning step are performed in the same furnace.

7. A manufacturing method for a plasma display panel according to claim 4 or 5, wherein said phosphor burning step and said vacuum burning step are performed in different furnaces.

8. A manufacturing method for a plasma display panel according to claim 6 or 7, wherein the air atmosphere in the furnace is replaced by a dry nitrogen atmosphere or a dry air atmosphere during or before temperature rising in said phosphor burning step.

9. A manufacturing method for a plasma display panel according to claim 6 or 7, wherein the air atmosphere in the furnace is replaced by a dry nitrogen atmosphere or a dry air atmosphere during or after temperature falling in said phosphor burning step.

10. A manufacturing method for a plasma display panel according to claim 6 or 7, wherein the air atmosphere in the furnace is replaced by an oxygen-rich atmosphere during or after temperature falling in said phosphor burning step.

11. A manufacturing method for a plasma display having a first panel and a second panel with a discharge space defined between said first panel and said second panel, comprising the steps of:
forming a rib for partitioning said discharge space and a phosphor layer for emitting light according to ultraviolet rays produced in said discharge space, on a second substrate forming said second panel; and
burning said substrate formed with said rib and said phosphor layer in a vacuum of 10 Pa or less in a temperature range of 350 to 550° C. after said forming step.

12. A manufacturing method for a plasma display according to claim 11, wherein said substrate formed with said rib and said phosphor layer is burned in a vacuum of 1 Pa or less in said vacuum burning step.

13. A manufacturing method for a plasma display according to claim 11, wherein said substrate formed with said rib and said phosphor layer is burned in a vacuum of 1×10⁻¹ Pa or less in said vacuum burning step.

14. A manufacturing method for a plasma display according to any one of claims 11 to 13, further comprising the step of burning said phosphor layer on said second substrate in the air before said vacuum burning step.

15. A manufacturing method for a plasma display according to claim 14, further comprising the step of burning said rib on said substrate in the air before said phosphor burning step.

16. A manufacturing method for a plasma display according to claim 14 or 15, wherein said phosphor burning step and said vacuum burning step are performed in the same furnace.

17. A manufacturing method for a plasma display according to claim 14 or 15, wherein said phosphor burning step and said vacuum burning step are performed in different furnaces.

18. A manufacturing method for a plasma display according to claim 16 or 17, wherein the air atmosphere in the furnace is replaced by a dry nitrogen atmosphere or a dry air atmosphere during or before temperature rising in said phosphor burning step.

19. A manufacturing method for a plasma display according to claim 16 or 17, wherein the air atmosphere in the furnace is replaced by a dry nitrogen atmosphere or a dry air atmosphere during or after temperature falling in said phosphor burning step.

20. A manufacturing method for a plasma display according to claim 16 or 17, wherein the air atmosphere in the furnace is replaced by an oxygen-rich atmosphere during or after temperature falling in said phosphor burning step.

21. A manufacturing method for a plasma display according to any one of claims 11 to 20, further comprising the steps of joining said first panel and said second panel after said vacuum burning step to form said discharge space partitioned by said rib between said first panel and said second panel, and sealing a discharge gas having a predetermined pressure into said discharge space.
